(19) United States
(12) Patent Application Publication
(10) Pub. No.: US 2026/0287066 A1
(43) Pub. Date: Sep. 24, 2026

(54) VALVE APPARATUS WITH A DOMED VALVE DISC

(71) Applicant: Wanner Engineering, Inc., Minneapolis, MN (US)

(72) Inventor: Richard David Hembree, Port Coquitlam (CA)

(73) Assignee: Wanner Engineering, Inc., Minneapolis, MN (US)

(21) Appl. No.: 19/458,254

(22) Filed: Jan. 23, 2026

Related U.S. Application Data
(60) Provisional application No. 63/773,998, filed on Mar. 18, 2025.

(51) Int. Cl. F16K 1/36; F16K 15/02; F16K 15/06; F16K 15/14; F16K 27/02

(52) U.S. Cl. CPC F16K 1/36; F16K 15/028; F16K 15/063; F16K 15/148; F16K 27/0227

(57) ABSTRACT

A check valve apparatus has a valve disc with a convex first side facing a first axial direction and defining a fluid engagement second surface, and a second side opposite the first side, the second side having a concave surface. A guide rod extends from the second side along a valve axis. A valve seat has a central opening aligned with the axial direction and engages the valve disc in a closed position. The valve disc may have a substantially constant thickness between the convex valve engagement surface of the first side and the concave surface of the second side. A spring biases the valve disc toward engagement with the valve seat. For some applications, a replaceable engagement insert, such as a carbide insert, engages the valve seat having an engagement surface.

### CROSS-REFERENCE TO RELATED APPLICATION(S)

This application claims the benefit of U.S. Provisional Application No. 63/773,998 filed Mar. 18, 2025, for “VALVE APPARATUS WITH A DOMED VALVE DISC” are hereby incorporated by reference in their entirety.

### BACKGROUND OF THE INVENTION

The present invention is directed to a valve having a domed valve disc that achieves advantages in strength, weight, and cost over existing valves, for use in a positive displacement, reciprocating fluid pump.

In a reciprocating positive displacement pump the valves are opened when flow from the pumping chamber increases the pressure on one side of the valve. In particular such pumps used in larger applications rely heavily on the precise and reliable operation of valve mechanisms to ensure efficient and accurate fluid displacement. A critical component of these valves is the valve disc, which must be precisely guided to land correctly on the valve seat. A spring is used to close the valve disc. The speed that the pump can operate is dependent largely on the speed that the valve closes. Since moving from the opened position to the closed position requires the valve disc to accelerate, the valve's mass plays a significant role in how fast it closes. It is therefore beneficial to minimize the mass of the valve disc.

Such valves require guides to ensure proper alignment during operation. The valve guides are another source of mass in the moving portion of the valve. Traditional guiding mechanisms for valve discs include wing guides, edge guides, and rod guides. Among these, rod-guided discs are commonly used, where the guiding rod can be positioned on the upper side, lower side, or both sides of the disc.

Examples of valves and guides are shown in U.S. Pat. No. 10,711,778 to Buckley, entitled Frac Pump Valve Assembly and U.S. Pat. No. 7,341,435 to Vicars, entitled Fluid End. An example of a conventional rod-type valve assembly, generally designated A, is shown in FIGS. 1-4. The valve assembly is configured for use in a positive displacement pump such as, for example, the pump 1000, shown in FIG. 19. The valve assembly A generally includes a planar valve disc B, as shown in FIGS. 1-2. A rod C extends from the disc B. The valve A is biased by a spring D constrained between a valve seat E and a valve mount F. The rod C extends through a center hole G in the valve disc B and a central passage H through the valve seat E. A nut I or another similar fastener retains the rod C. The valve A closes by the spring D pushing the disc B to engage the valve seat E and opens by the valve disc B being moved apart from the valve seat E.

Moreover, an example of a prior art top guided style valve is shown in FIGS. 5 and 6. Furthermore, an example of a wing guided style valve is shown in FIG. 7. In addition, an example of a single piece prior art bottom rod guided valve element is shown in FIGS. 8 and 9.

The strength of the valve disc is also an important feature. High pressure pumps require the valve to have a long life while supporting the full pressure of the pump when the valve is closed. Making the valve strong enough to withstand this pressure usually results in a thicker and heavier disc. Therefore, the strength and weight goals compete.

Although rod-guided valve discs generally provide satisfactory performance, such valve discs involve significant manufacturing challenges. When constructed from costly materials such as sintered carbide, producing the disc and rod as a single piece can be prohibitively expensive. As a cost-saving measure, an alternative approach involves manufacturing the disc and rod as separate components and subsequently fastening them together through a central hole in the disc. Unfortunately, such a configuration may introduce issues related to stress concentration around the hole, which can be extremely high, necessitating a thicker disc to withstand the stress, which in turn increases the mass and inertia of the moving valve component.

It is appreciated that valve disc geometry may significantly reduce the stress concentration at the central hole and may achieve a significant reduction in stress at the hole's bottom opening. Moreover, geometry combined with a carbide ring insert at the disc's contact zone, would not only further reduce the amount of expensive and heavy carbide material required but also allow the primary structure of the disc to be made from relatively inexpensive steel.

It can therefore be seen that there is a need for a lighter, more cost-effective valve with a disc that maintains the necessary strength and wear resistance even at high pressures. Such a valve should use advantageous geometry and materials that achieve superior performance and use with fluid having a high percentage of solids and be adaptable to pumps over a wide range of sizes. The present invention addresses these, as well as other problems associated with valves and valve discs for reciprocating positive displacement pumps.

### SUMMARY OF THE INVENTION

The present invention is directed to a check valve having a valve disc with a domed shape that significantly reduces central stress, enabling the use of minimal material while maintaining structural integrity.

A pump, such as a diaphragm pump, may be driven by connection to a rotating crankshaft mounted in a crankcase. In some embodiments, a manifold houses one or more check valves. The pump may include multiple diaphragms and associated components connected to the crankshaft.

A check valve is configured with a domed shape to reduce stress, particularly in the center, allowing a through hole while reducing stress and maintaining strength with a lower mass than conventional designs. It was found that by making the disc in the shape of a dome the high stress area located at the bottom opening of the disc hole is greatly reduced. In one example, a comparison of two-disc assemblies of similar mass, one with a common flat disc, and one domed, the stress was reduced from 18,000 psi to 300 psi at the hole opening relative to a comparable conventional valve disc under similar stress. This dramatic reduction in stress is because the domed shape puts the bottom center of the disc in compression rather than in tension as with a flat disc.

The valve assembly may include an axially extending guide rod removably mounted to a first side of the valve disc and may include a threaded connection. The valve disc includes an outer first side and an inner second side of the valve disc. The second side is domed. In some embodiments, the first side of the valve disc is curved, and a portion of the fluid engagement surface is convex and substantially parallel to the concave surface of the second side. The valve disc may therefore have a substantially constant thickness between the convex valve engagement surface of the first side and the concave surface of the second side.

The valve assembly has a valve seat having a central opening aligned with the axial direction, the valve seat configured to engage the valve disc in a closed position. The valve assembly further includes a spring or other element biasing the valve disc toward engagement with the valve seat.

In some embodiments, the valve disc and the guide rod are an integrally formed element. Moreover, the valve disc and the rod may be a monolithic element.

An additional embodiment uses a carbide ring insert at the contact zone. Such a configuration further reduces the amount of the expensive, heavy material, and allows the use of a relatively inexpensive steel for the main part of the disc. Additionally, the incorporation of a carbide ring insert at the contact zone optimizes material usage and cost, offering a practical solution for manufacturing efficient and durable valve discs for positive displacement pumps. Such an insert may be replaceable and is particularly suited for fluids with high solids content or other high wear applications.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference letters and numerals indicate corresponding structure throughout the several views:

FIG. 1 is a side elevational view of a planar prior art valve disc;

FIG. 2 is a sectional view taken along line 2-2 of FIG. 1;

FIG. 3 is a side elevational view of a prior art bottom rod guided valve;

FIG. 4 is a sectional view taken along line 4-4 of FIG. 3;

FIG. 5 is a side elevational view of a prior art top guided valve;

FIG. 6 is a sectional view taken along line 6-6 of FIG. 5;

FIG. 7 is a perspective view of a prior art wing guided valve;

FIG. 8 is a side elevational view of a single piece prior art bottom rod guided valve;

FIG. 9 is a side sectional view taken along line 9-9 of FIG. 8;

FIG. 10 is a side elevational view of a bottom rod guided domed valve assembly according to the principles of the present invention;

FIG. 11 is a side sectional view taken along line 11-11 of FIG. 10;

FIG. 12 is a side sectional view of the valve assembly of FIG. 11 ins an open position;

FIG. 13 is a side elevational view of a domed disc for the bottom rod guided domed valve assembly shown in FIG. 8;

FIG. 14 is a side sectional view taken along line 14-14 of FIG. 13;

FIG. 15 is a side elevational view of a single piece bottom rod guided domed valve according tot the principles of the present invention;

FIG. 16 is a side sectional view taken along line 16-16 of FIG. 15;

FIG. 17 is a side elevational view of a domed disc with a carbide insert for the bottom rod guided domed valve assembly shown in FIG. 10; and

FIG. 18 is a side sectional view taken along line 18-18 of FIG. 17;

FIG. 19 is a sectional view of a pump according to the principles of the present invention including valve assemblies as shown in FIG. 10;

FIG. 20 is a sectional view of a fluid end of a pump including valve assemblies as shown in FIG. 10;

FIG. 21 is a stress diagram showing stresses for a prior art flat disc assembly; and

FIG. 22 is a stress Diagram showing stresses for a domed disc assembly comparable to the disc assembly shown in FIG. 21.

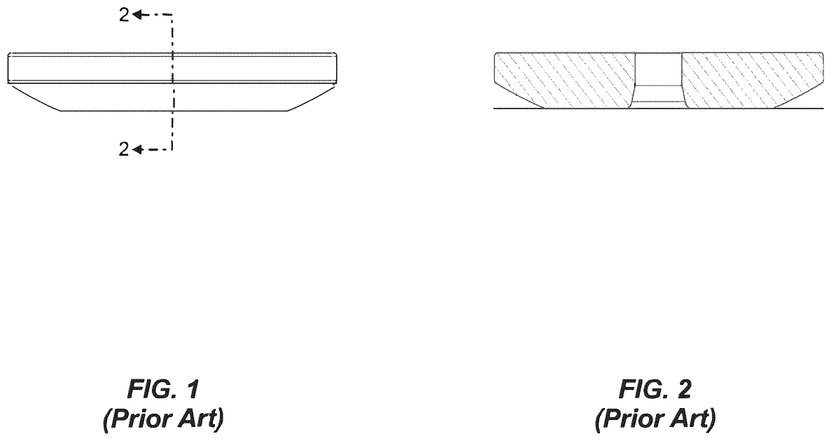

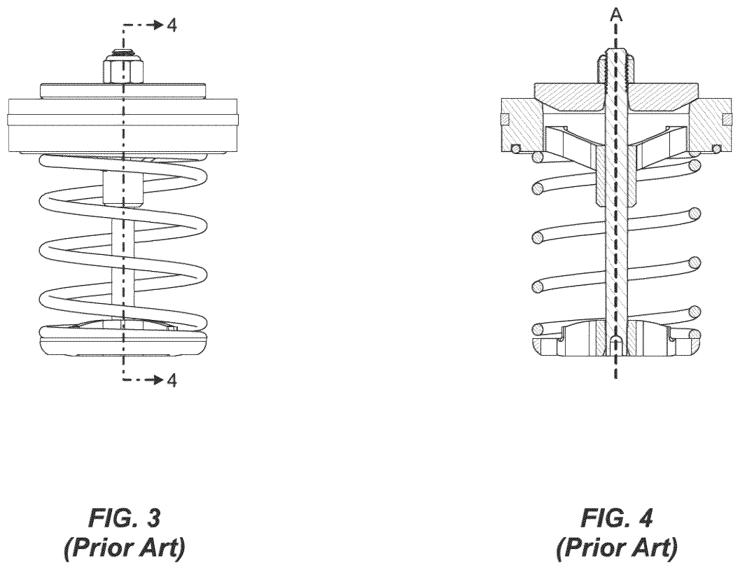

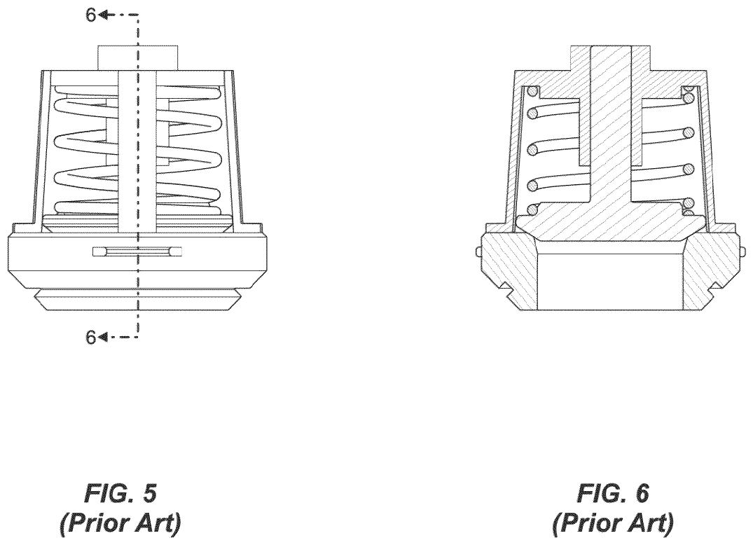

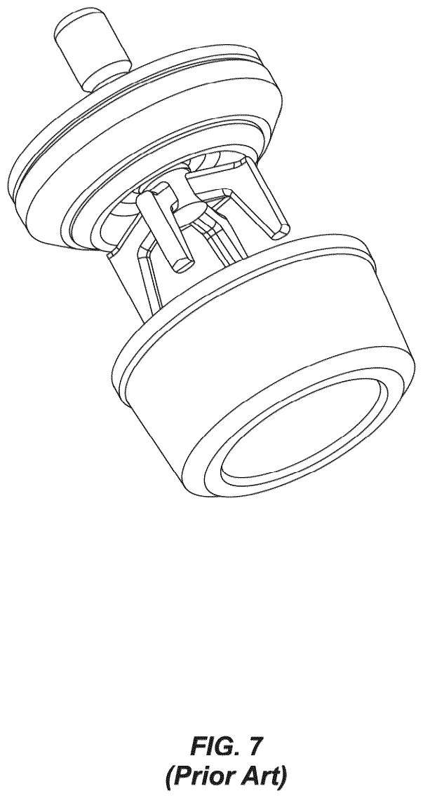

### DETAILED DESCRIPTION OF THE PREFERRED EMBODIMENTS

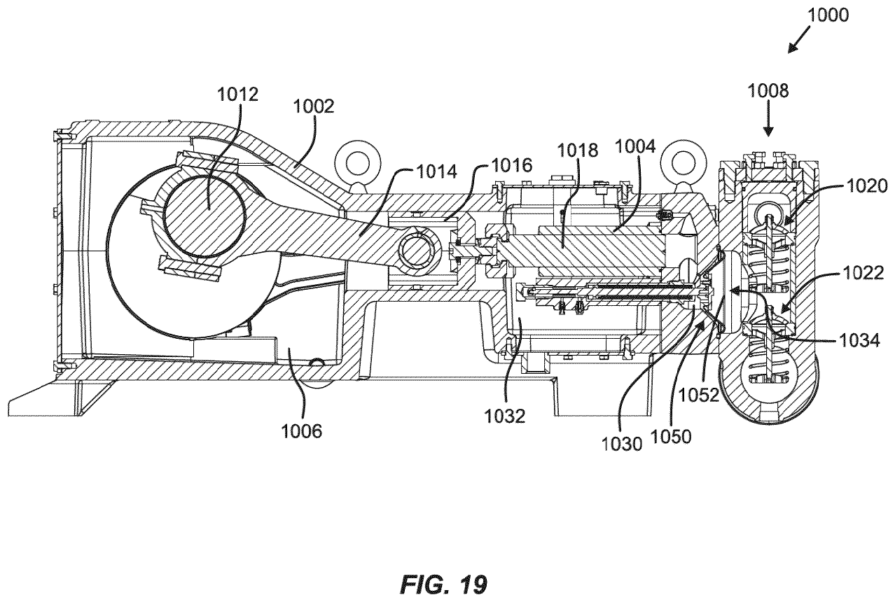

Referring now to the Figures and in particular to FIG. 19, a fluid pump 1000 is shown, such as a hydraulically driven diaphragm pump, although other reciprocating positive displacement pumps are also foreseen. The diaphragm pump 1000 is driven by connection to a rotating crankshaft 1012 mounted in a crankcase 1002. A manifold 1008 houses one or more check valves including inlet check valves 1020, and discharge check valves 1022. The pump 1000 may include multiple diaphragms assemblies and associated components connected to the crankshaft 1012.

In the embodiment shown, the pump 1000 includes a diaphragm assembly generally designated 1050 including a diaphragm 1052. The diaphragm 1052 is driven by hydraulic fluid in a hydraulic chamber 1030, a reservoir 1006, and a plunger chamber 1032. The pumping chamber 1034 is on a hydraulic side of the diaphragm 1052. The hydraulic fluid has flowable access to engage the diaphragm assembly 1050 through the hydraulic chamber 1030. The hydraulic fluid is forced against the diaphragm 1052 to deflect the hydraulic side of the diaphragm 1052 and impart a pumping action on the fluid to be pumped. A piston housing 1004 defines the plunger chamber 1032. The crankshaft 1012 includes a connecting rod 1014 attached to a slider 1016 in the crankcase 1002. The slider 1016 is connected to a piston-type plunger 1018 that reciprocates and drives the hydraulic fluid from the hydraulic chamber 1030 to engage the diaphragm 1052. It can be appreciated that in some embodiments, the crankshaft 1012 may attach to multiple different diaphragm assemblies 1050 within the same pump and may include offset portions along the shaft so that individual diaphragms are synchronized to pump at various stages of the pumping stroke.

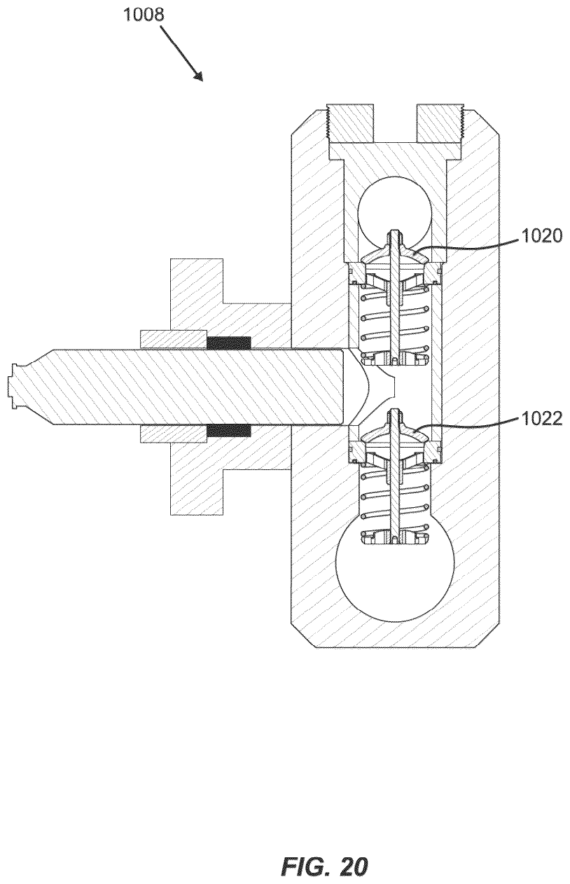

As shown in FIG. 20, a manifold 1008 houses inlet check valves 1020 and discharge check valves 1022. In embodiments with multiple diaphragms, the pump 1000 includes an inlet check valve 1020 and a discharge check valve 1022 for each of the diaphragms 1052. The check valves 1020, 1022 provide for controlled suction and discharge of the pumped fluid.

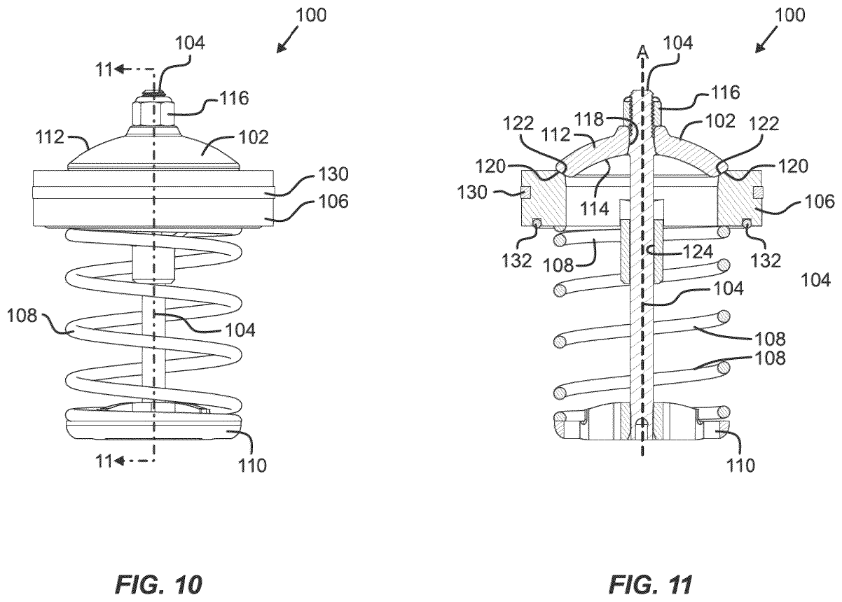

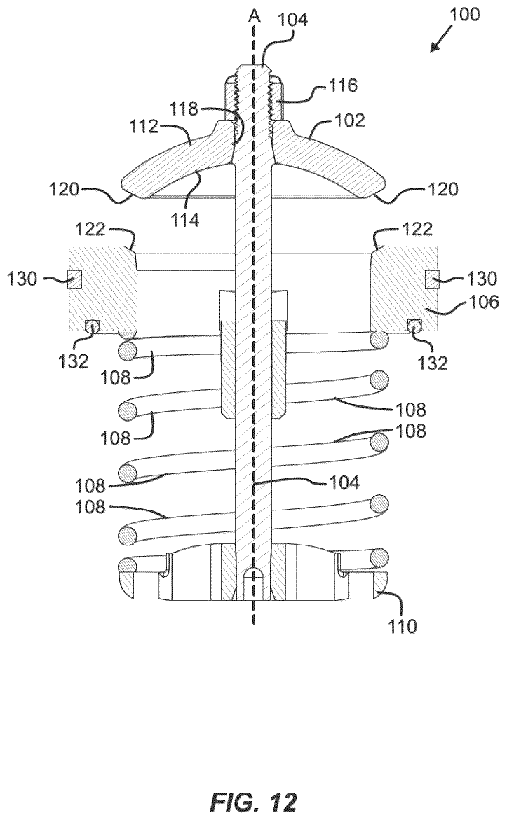

Referring now to FIGS. 10-12, a check valve assembly 100 according to the present invention is shown. A movable valve disc 102 has a rod, or stem, 104 extending therefrom. The valve disc 102 is movable longitudinally/axially into and out of engagement with a valve seat 106 to open and close the valve assembly 100. The valve disc 102 may have a generally round periphery. The valve seat 106 typically has a similar periphery and is axially aligned with the valve disc 102. It is appreciated that the valve assembly 100 is closed when the valve disc 102 engages the valve seat 106 as shown in FIG. 11, and the valve assembly 100 is open when the valve disc 102 is spaced apart from the valve seat 106, as shown in FIG. 12. It is appreciated that the valve assembly 100 may be used as the inlet check valve 1020 or the discharge check valve 1022 shown in FIGS. 19-20. A spring 108 engages a valve assembly frame 110 as well as the valve seat rod 106 to bias the valve assembly toward the closed position. Other biasing arrangements with other configurations are also foreseen.

As shown in FIGS. 11-12, the rod 104 protrudes through a center orifice 118 extending through the valve disc 102 as well as a center passage 124 extending through the valve seat 106. The rod 104 may be threaded and a retainer, such as a nut 116 attaches to the rod 104 above the valve disc 102. The opposite end of the rod 104 attaches to the frame. O-ring type gaskets 130, 132 ensure a proper fluidic seal is maintained.

In the embodiment shown, the valve assembly 100 is configured with the spring 108 retained between the valve seat 106 and the lower frame 110 and biasing the valve disc 102 toward a closed position. When the valve assembly 100 is closed, an engagement surface 120 of the valve disc 102 engages a complementary engagement surface 122 on the valve seat 106. It is appreciated that the engagement surfaces 120 and 122 may both extend obliquely relative to the longitudinal axis A of the valve assembly 100. The slanted orientation of the engagement surfaces 120 and 122 acts to self-align valve disc 102 and the valve seat 106. Moreover, the parallel surfaces provide excellent engagement and seating and are able to correctly align and engage under high pressures.

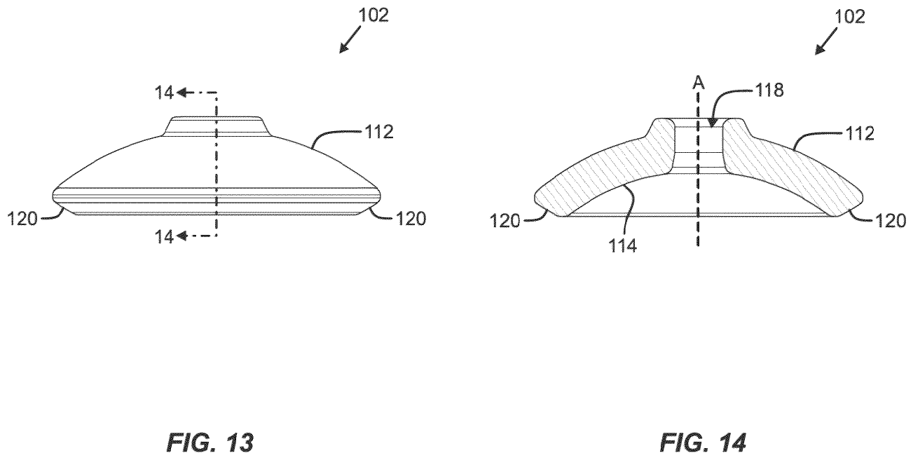

Referring now to FIGS. 13 and 14, the valve disc 102 is advantageously configured with a domed configuration. The valve disc 102 has a concave arcing inner surface 114 (second side) extending from the engagement surface 120 to the center orifice 118. Moreover, the valve disc 102 has a convex outer surface 112 (first side) that arcs from the periphery to the center orifice 118. In one preferred embodiment the arcs of the convex outer surface 112 and the concave inner surface 114 are preferably centered about a same valve axis A or closely spaced axes and maintain a substantially constant thickness. The valve disc 102 with a domed configuration provides significant advantages for structural strength. The curved, arcing design distributes stress more evenly across the entire disc 102. Moreover, the domed valve disc 102 is able to withstand greater pressure while using less mass than comparable discs using conventional designs, thereby improving valve responsiveness and performance.

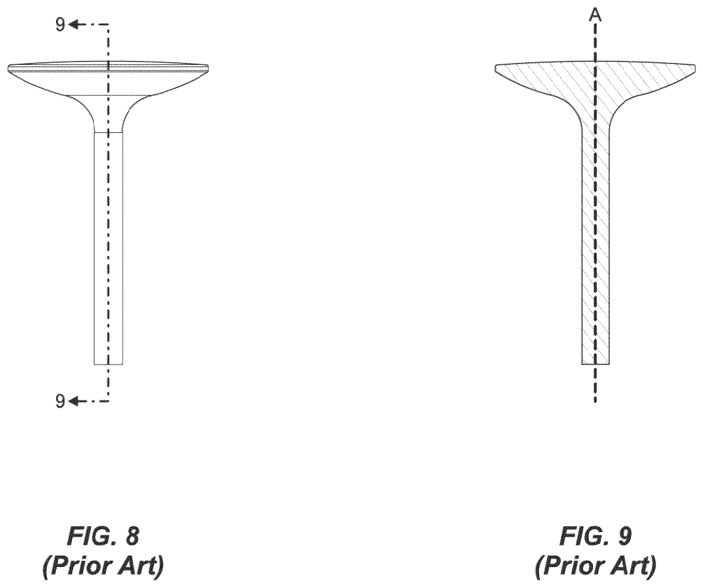

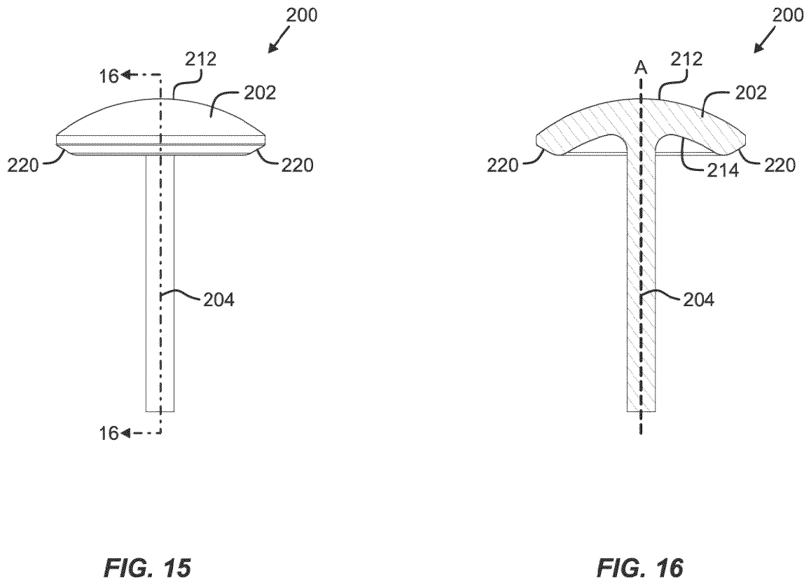

Referring now to FIGS. 15 and 16, a second embodiment of a valve disc and rod assembly 200 is shown. A valve disc 202 is integrally formed with a rod 204. In some embodiments, the valve disc 202 and the rod 204 may be formed of continuous monolithic material. The integral assembly 200 is similar in configuration to the valve disc 102 and rod 104 but is made as a single element and eliminates the center orifice, retainer, and engagement portions. The valve disc 202 includes an engagement surface 220 configured to engage a complementary engagement surface of a valve seat. Moreover, the valve disc 202 includes a domed or arcing outer surface 212 and an arcing inner surface 214. This configuration is similar to valve disc 102 and provides advantages for mass and strength. As compared to integrally formed planar valve disc and rod assemblies, such as shown in FIGS. 8 and 9, the integral valve disc and rod assembly 200 provides for operating under higher pressures while having less mass and provides superior performance over prior art valves.

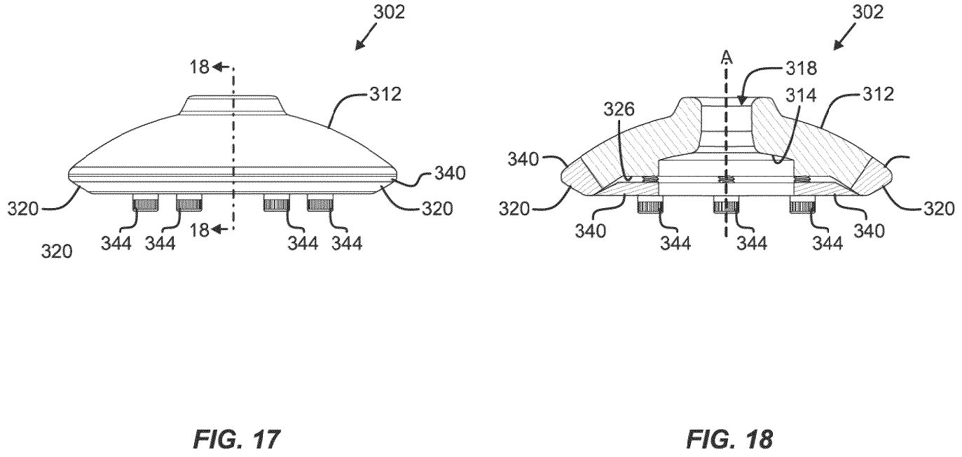

Referring to FIGS. 17 and 18, a third embodiment is shown with a valve disc 302 having a carbide insert 340. The valve disc 302 is similar to valve disc 102 and includes a center orifice 318 for receiving a complementary rod. The valve disc 302 has an engagement surface 320 for engaging a complementary surface on a valve seat. The valve disc 302 has an outer arcing surface 312 and an arcing inner surface 314. However, a portion of the inner surface 326 is straight rather than domed and is obliquely aligned relative to an axial direction. The carbide insert 340 is a generally annular element and includes angled edge portions to seat against the straight portion of the inner surface 326 of the valve disc. Mounting screws 344 or other mounting elements attach the carbide insert 340 to the body of the valve disc 302. The carbide insert 340 provides improved strength and wear characteristics over conventional metal materials. However, with only the insert 340 being made of carbide, rather than having the entire valve disc made of carbide, the valve disc 302 has less mass and is less expensive. The valve disc 302 achieves advantages for wear and strength over valves without carbide, while also being less expensive and lighter than carbide valve discs.

### Example Stress Analysis Comparison

A comparison of stress for a conventional prior art valve disc having a flat shape with a center hole for a guide rod with a domed shape valve disc according to the principles of the present invention, with the same center hole demonstrates the surprising advantages of the present invention. For comparing performance, in the example shown, the valve discs have the same mass.

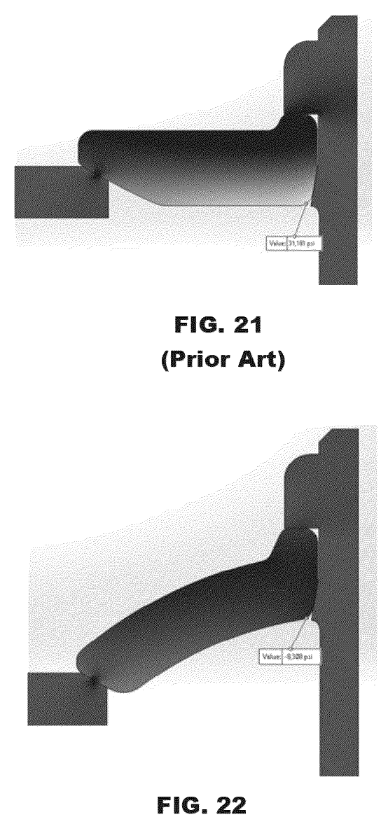

In the example shown in FIGS. 21 and 22, the stress in both valves is simulated by applying 2000 psi of pressure downward to simulate the closed position stress, which is the highest stress. The stress plot is for the direction normal to the plot, so the diagram best shows the hoop stress at the hole opening. A positive number represents tensile stress, while a negative number represents compressive stress. In FIGS. 21 and 22, tensile stresses appear as lighter portions while compressive stresses appear as darker portions.

In the stress analysis performed, the comparable flat disc shows a tensile stress of 31,181 psi at the hole opening. Such a stress would cycle from zero to this stress every stroke of the pump, which could cause a fatigue crack to form.

In the diagram of FIG. 22, the domed valve shows compressive stress of −8,308 at the hole opening. Cycling between zero and a compressive value would not cause fatigue cracking. An improvement magnitude difference of 39,489 psi is achieved from the domed shape.

It is appreciated that the improved valve assemblies 100, 200, 300 of the present invention achieve advantageous configurations that achieve surprising results for stress management, reduction in mass, and valve performance that is not possible with the prior art.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A valve assembly configured to move along a valve axis, the valve assembly comprising:
a valve disc having a first side facing a first axial direction and defining a fluid engagement surface, and a second side opposite the first side, the second side having a concave surface;
a rod extending from the second side along the valve axis.

2. The valve assembly according to claim 1, wherein the rod is removably mounted to the valve disc.

3. The valve assembly according to claim 1, wherein the rod is threadedly attached to the valve disc.

4. The valve assembly according to claim 1, wherein the first side of the valve disc is convex.

5. The valve assembly according to claim 1, wherein the first side of the valve disc is curved and wherein a portion of the fluid engagement surface is substantially parallel to the concave surface of the second side.

6. The valve assembly according to claim 1, wherein the valve disc has a substantially constant thickness between the valve engagement surface of the first side and the concave surface of the second side.

7. The valve assembly according to claim 1, a valve seat having a central opening aligned with the valve axis, the valve seat configured to engage the valve disc in a closed position.

8. The valve assembly according to claim 1, wherein the valve disc and the rod comprise an integrally formed element.

9. The valve assembly according to claim 1, wherein the valve disc and the rod comprise a monolithic element.

10. The valve assembly according to claim 1, further comprising a spring biasing the valve disc toward engagement with the valve seat.

11. The valve apparatus according to claim 1, wherein the valve disc comprises a replaceable engagement insert configured to engage the valve seat having an engagement surface.

12. The valve apparatus according to claim 11, wherein the insert comprises a carbide insert.

13. A reciprocating positive displacement pump check valve assembly configured to move along a valve axis, the valve assembly comprising:
a valve disc having a first side facing a first axial direction and defining a fluid engagement surface, and a second side opposite the first side, the second side having a concave surface;
a rod extending from the second side along the valve axis;
a valve seat having a central opening aligned with the valve axis, the valve seat configured to engage the valve disc in a closed position.

14. The valve assembly according to claim 13, wherein the first side of the valve disc is convex.

15. The valve assembly according to claim 13, wherein the first side of the valve disc is curved and wherein a portion of the fluid engagement surface is substantially parallel to the concave surface of the second side.

16. The valve assembly according to claim 13, wherein the valve disc has a substantially constant thickness between the valve engagement surface of the first side and the concave surface of the second side.

17. The valve assembly according to claim 13, further comprising a spring biasing the valve disc toward engagement with the valve seat.

18. The valve assembly according to claim 13, wherein the valve disc comprises a replaceable engagement insert configured to engage the valve seat and has an engagement surface.

19. A check valve apparatus comprising:
a valve disc having a first side facing a first axial direction and defining a fluid engagement surface, and a second side opposite the first side, the second side having a concave surface;
a rod extending from the second side along a valve axis;
a valve seat having a central opening aligned with the axial direction, the valve seat configured to engage the valve disc in a closed position.
